(19) United States
(12) Patent Application Publication
(10) Pub. No.: US 2007/0289830 A1
(43) Pub. Date: Dec. 20, 2007

(54) Lock-up clutch mechanism and method for manufacturing such mechanism

(75) Inventors: Nobuyoshi Suzuki, Fukuroi-shi (JP); Hirotsugu Suzuki, Fukuroi-shi (JP); Hideki Matsumoto, Fukuroi-shi (JP); Hideaki Takabayashi, Fukuroi-shi (JP); Chisato Yagi, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-Warner K.K.

(21) Appl. No.: 11/808,221

(22) Filed: Jun. 7, 2007

(30) Foreign Application Priority Data
Jun. 20, 2006 (JP) 2006-170345

(51) Int. Cl. F16H 45/02

(52) U.S. Cl. 192/3.29

(57) ABSTRACT

The present invention provides a lock-up clutch mechanism for a torque converter, comprising a lock-up piston and a front cover having an engagement surface capable of being engaged with the lock-up piston and wherein one of the lock-up piston and the front cover is provided with a friction material sticking surface to which a friction material is stuck and the friction material sticking surface has a raised configuration protruding in an axial direction.

### BACKGROUND OF THE INVENTION

1. Field of the Invention

The present invention relates to a lock-up clutch mechanism used as in a torque converter of an automatic transmission of a vehicle, and more particularly, it relates to an improvement in a friction sliding surface of such a lock-up clutch mechanism.

2. Description of the Related Art

Torque converters used in automatic transmissions have an advantage that starting, acceleration and deceleration can be performed smoothly and, at the same time, have a disadvantage that transmission efficiency is worsened because a power is transmitted through fluid. Thus, in some cases, it has been designed so that, if a vehicle speed exceeds a predetermined value, in order to reduce energy loss and to reduce consumption of fuel, an engine and driving wheels are directly connected to each other by operating a lock-up clutch mechanism including a lock-up clutch.

Further, in more recent years, to further reduce the consumption of fuel, the lock-up clutch mechanism has been operated also in a low speed operation of the vehicle. In this case, in order to reduce vibration of the engine and transmission shock during the low speed operation of the vehicle, a so-called slip lock-up control in which lock-up control is performed while maintaining a slip amount at a predetermined number of revolutions is performed.

In general, in the lock-up clutches, self vibration called as judder may be generated, thereby worsening comfort of the vehicle considerably. Particularly, the judder is greatly influenced upon imbalance of circumferential face pressure distribution during the slip on the friction surfaces. The imbalance of the face pressure distribution is greatly influenced upon accuracy of the friction surfaces; thus, circumferential dispersion on the friction surface is caused by minute undulation of a piston of the lock-up clutch and/or distortion of attaching bolts for a drive plate provided in a front cover.

In order to suppress such judder, for example, in Japanese Patent Application Laid-open No. 2004-011710, it has been proposed that reduction of a μ-V property of a friction surface is suppressed by differentiating density between a radial inner diameter side and a radial outer diameter side of a friction material secured to a lock-up piston by compressing the friction material or by making the friction material as a tapered shape.

However, as mentioned above, since the occurrence of the judder is caused mainly by the imbalance of the circumferential face pressure distribution during the slip on the friction surfaces, the above-mentioned Japanese Patent Application Laid-open No. 2004-011710 did not provide satisfactory countermeasure for the judder.

### SUMMARY OF THE INVENTION

Accordingly, an object of the present invention is to provide a lock-up clutch mechanism which can make circumferential face pressure of a friction surface more uniform regardless of a change in an urging force of a piston of a lock-up clutch, thereby preventing judder.

To achieve the above object, the present invention provides a lock-up clutch mechanism for a torque converter, comprising a lock-up piston and a front cover having an engagement surface capable of being engaged with the lock-up piston and wherein one of the lock-up piston and the front cover is provided with a friction material sticking surface to which a friction material is stuck and the friction material sticking surface has a raised configuration protruding in an axial direction.

Further, to achieve the above object, the present invention provides a method for manufacturing a lock-up clutch mechanism, wherein the raised configuration is formed by cutting the friction material sticking surface.

Further, to achieve the above object, the lock-up clutch mechanism manufacturing method of the present invention further comprises a step of sticking the friction material by urging the friction material by means of an urging surface having substantially the same configuration as the raised configuration of the friction material stacking surface.

Since the friction material sticking surface has the raised configuration protruding in the axial direction, even if the piston of the lock-up clutch is urged against the front cover with a relatively small urging force during the lock-up slip, contact face pressure at a most raised portion becomes great and is made substantially uniform in a circumferential direction due to flexibility of the friction material, thereby improving evenness of circumferential friction face pressure.

Further, even if the urging force of the piston is changed, since the evenness of the circumferential friction face pressure can be maintained more stably, the judder can be reduced.

Further features of the present invention will become apparent from the following description of exemplary embodiments with reference to the attached drawings.

### BRIEF DESCRIPTION OF THE DRAWINGS

FIG. 1 is an axial partial sectional view of a torque converter having a lock-up clutch mechanism to which various embodiments of the present invention can be applied.

FIG. 2 is an enlarged partial sectional view of a piston and a friction material, showing a first embodiment of the present invention.

FIG. 3 is an enlarged partial sectional view of a piston and a friction material, showing a second embodiment of the present invention.

FIG. 4 is an enlarged partial sectional view of a piston and a friction material, showing a third embodiment of the present invention.

FIG. 5 is a schematic view showing a difference between a most raised portion and a base or bottom portion of a friction material sticking surface in various embodiments of the present invention.

### DESCRIPTION OF THE EMBODIMENTS

Now, various embodiments of the present invention will be fully explained with reference to the accompanying drawings. In the drawings, the same parts or elements are designated by the same reference numerals. Further, it should be noted that embodiments which will be described hereinbelow are merely examples of the present invention and do not limit the present invention in all senses.

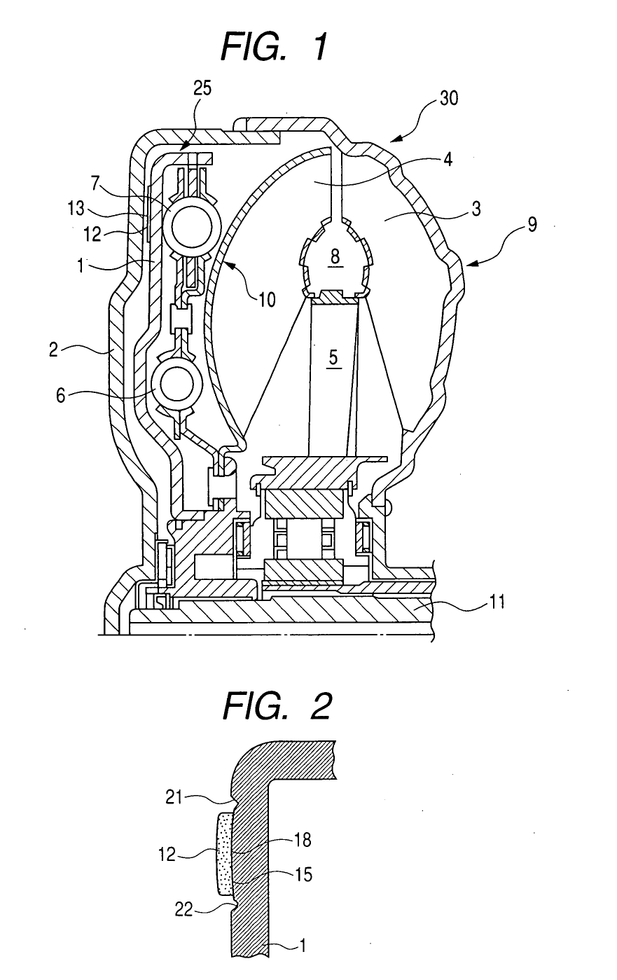

FIG. 1 is an axial partial sectional view of a torque converter 30 having a lock-up clutch mechanism to which various embodiments of the present invention can be applied, showing a released condition of a lock-up clutch. The torque converter 30 comprises a front cover 2 for forming a part of a housing of the torque converter 30, an impeller 9 as a donut-shaped vane-wheel secured to the front cover 2, a turbine 10 as a donut-shaped vane-wheel having vanes opposed vanes of the impeller 9, and a stator 5 rotatably provided between the impeller 9 and the turbine 10. The impeller 9, turbine 10 and stator 5 constitute a main body of the torque converter.

The impeller 9 is connected to a crankshaft (not shown) of an engine of a vehicle so that it can be rotated together with the front cover 2 when the engine is driven or rotated. Further, the turbine 10 is directly connected to an output shaft 11 and is connected to vehicle wheels (not shown) via speed change mechanism (not shown). The stator 5 is disposed between inner surfaces of the impeller 9 and the turbine 10 at substantially central portions thereof and has a function for changing a flow of fluid filled within the torque converter 30.

Between an inner surface of the front cover 2 and an outer surface of the turbine 10, there is provided a lock-up clutch or lock-up piston 1 as an annular plate. This lock-up piston has a surface, opposed to the inner surface of the front cover 2, to which a friction material 12 is stuck by an adhesive. The lock-up piston constitutes a lock-up clutch mechanism and serves to provide a piston operation and is rotated together with the output shaft 11. A friction surface 13 of the friction material 12 is opposed to the inner surface of the front cover 2. Incidentally, for simplicity's sake of the explanation, hereinafter, the “lock-up piston” is referred to merely as “piston”.

Between the outer surface of the turbine 10 and the piston 1, there is provided a damper mechanism adapted to dampen shock caused upon engagement of the piston 1 and comprising coil springs 6 and 7. Further, a central space 8 is defined at a central region of the torque converter 30.

Next, an operation of the piston 1 will be described. When a speed of a vehicle exceeds a predetermined value, a feedback control is performed by a control mechanism (not shown) so that a flow of fluid in the torque converter 30 defined by the impeller 9 and the turbine 10 is automatically changed. Due to such a change, the piston 1 is urged against the inner surface of the front cover 2 to engage the friction material 12 with the inner surface of the front cover 2 to establish a direct connection condition of the piston 1, with the result that a driving force of the engine is directly transmitted to the output shaft 11. Accordingly, since a driving side and an output side are mechanically locked-up without the interposition of the fluid (directly connected), loss of the fluid can be prevented and fuel consumption can be reduced.

Incidentally, the torque converter 30 is connected to a hydraulic pressure controlling mechanism (not shown), and the hydraulic pressure controlling mechanism serves to change (increase or decrease) an amount of oil to maintain the slip condition of the lock-up piston or piston 1, while keeping a pressure difference (difference between pressures across the piston 1) between two oil paths (i.e. outer peripheral side and inner peripheral side oil paths) sandwiching the piston 1 substantially constant.

### First Embodiment

FIG. 2 is an enlarged partial sectional view of the piston and the friction material, showing a first embodiment of the present invention. The piston 1 is provided with a friction material sticking surface 15 on its surface opposed to the front cover 2. Circumferential grooves 21 and 22 are provided in adjacent to outer diameter side and inner diameter side edges of the friction material sticking surface 15, respectively. The grooves 21 and 22 are used as lubricating oil passages for lubricating the friction surface.

As can be seen from FIG. 2, the friction material sticking surface 15 has a crown configuration or raised configuration protruding toward the front cover 2 from the grooves 21 and 22 in an axial direction. The raised configuration is formed from a continuous curved surface. In the first embodiment, a most raised portion 18 is located at a substantially central portion of the friction material sticking surface 15 in a radial direction.

The friction material 12 having a substantially uniform thickness is stuck to the friction material sticking surface 15 by an adhesive or the like. The stuck friction material 12 has a complementary configuration to the raised configuration of the friction material sticking surface 15. Accordingly, a surface configuration of the friction material 12 is also axially most protruded at a substantially central portion thereof in the radial direction.

### Second Embodiment

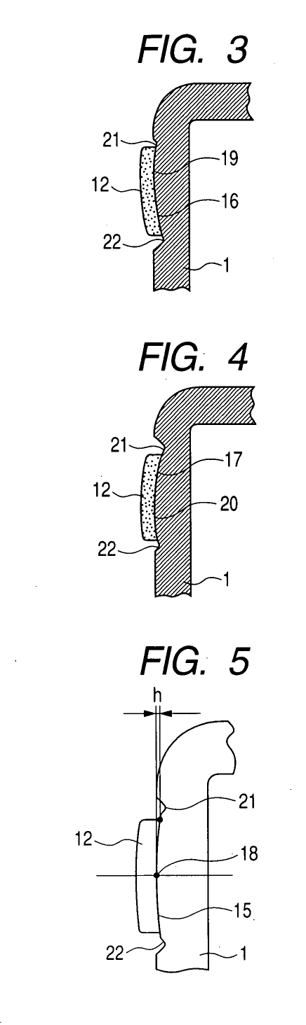

FIG. 3 is an enlarged partial sectional view of the piston and the friction material, showing a second embodiment of the present invention. A fundamental construction of the second embodiment is the same as that of the first embodiment.

As can be seen from FIG. 3, a friction material sticking surface 16 has a crown configuration or raised configuration protruding toward the front cover 2 from the grooves 21 and 22 in an axial direction. The raised configuration is formed from a continuous curved surface. In the second embodiment, a most raised portion 19 is offset toward an outer diameter side edge of the friction material sticking surface 16 and, thus, is located at the outer diameter side from the central portion.

The friction material 12 having a substantially uniform thickness is stuck to the friction material sticking surface 16 by an adhesive or the like. The stuck friction material 12 has a complementary configuration to the raised configuration of the friction material sticking surface 16. Accordingly, the friction material 12 is also axially most protruded at the portion 19 offset from the central portion toward the outer diameter side.

### Third Embodiment

FIG. 4 is an enlarged partial sectional view of the piston and the friction material, showing a third embodiment of the present invention. A fundamental construction of the second embodiment is the same as that of the first embodiment.

As can be seen from FIG. 4, a friction material sticking surface 17 has a crown configuration or raised configuration protruding toward the front cover 2 from the grooves 21 and 22 in an axial direction. The raised configuration is formed from a continuous curved surface. In the third embodiment, a most raised portion 20 is offset toward an inner diameter side edge of the friction material sticking surface 17 and, thus, is located at the inner diameter side from the central portion.

The friction material 12 having a substantially uniform thickness is stuck to the friction material sticking surface 17 by an adhesive or the like. The stuck friction material 12 has a complementary configuration to the raised configuration of the friction material sticking surface 17. Accordingly, the friction material 12 is also axially most protruded at the portion 20 offset from the central portion toward the inner diameter side.

FIG. 5 is a schematic view showing a difference between the most raised portion and the base or bottom portion of the friction material sticking surface in the various embodiments of the present invention. FIG. 5 shows the first embodiment as an example. A difference between the central portion of the friction material stacking surface 15 or the most raised portion 18 and the base portion is shown as h which is in a range of 0.03 mm to 0.25 mm.

In order to manufacture the lock-up clutch mechanism according to the present invention described above, first of all, the raised configuration is formed by cutting the friction material sticking surface of the piston 1 or the front cover 2. Further, the sticking of the friction material is performed by a member having a concave urging surface complementary to the raised configuration of the friction material sticking surface.

The raised configuration of the friction material sticking surface may be constituted by only curved line(s) or a combination of straight lines. Further, it may be constituted by a combination of straight line(s) and curved line(s). Thereafter, by sticking the friction material, the surface configuration of the friction material can be formed as the crowned configuration in the radial direction. Particularly, by forming the raised portion on the friction material sticking surface by the cutting operation, the crowned or raised friction surface of the friction material can be accurately manufactured.

In the above-mentioned embodiments, while an example that the friction material has the substantially annular shape was explained, the friction material does not necessarily have the annular shape, but the friction material may be formed by arranging friction material segments in an annular fashion. Further, the friction material 12 has different thicknesses along the radial direction.

Further, while only an example that the friction material sticking surface is formed on the lock-up piston was explained, of course, the friction material sticking surface may be formed on the front cover.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-170345, filed Jun. 20, 2006, which is hereby incorporated by reference herein in its entirety.

What is claimed is:

1. A lock-up clutch mechanism for a torque converter, comprising:
a lock-up piston; and
a front cover having an engagement surface capable of being engaged with said lock-up piston;
and wherein
one of said lock-up piston and said front cover is provided with a friction material sticking surface to which a friction material is stuck, and said friction material sticking surface has a raised configuration protruded in an axial direction.

2. A lock-up clutch mechanism according to claim 1, wherein said friction material sticking surface is provided on said lock-up piston.

3. A lock-up clutch mechanism according to claim 1, wherein said friction material sticking surface is provided on said front cover.

4. A lock-up clutch mechanism according to claim 2, wherein a most axially protruded portion of said friction material sticking surface is offset toward an outer diameter side from a radial central portion of said friction material.

5. A lock-up clutch mechanism according to claim 2, wherein a most axially protruded portion of said friction material sticking surface is offset toward an inner diameter side from a radial central portion of said friction material.

6. A lock-up clutch mechanism according to claim 1, wherein a most axially protruded portion and a base portion of said friction material sticking surface is in a range of 0.03 mm to 0.25 mm.

7. A lock-up clutch mechanism according to claim 1, wherein said friction material having a substantially uniform thickness is stuck to said friction material sticking surface.

8. A method for manufacturing a lock-up clutch mechanism according to claim 1, wherein said raised configuration is formed by cutting said friction material sticking surface.

9. A method for manufacturing a lock-up clutch mechanism according to claim 1, wherein the sticking of said friction material is performed by urging of a concave urging surface having substantially the same as said raised configuration of said friction material sticking surface.
